(19) United States
(12) Patent Application Publication
(10) Pub. No.: US 2026/0175398 A1
(43) Pub. Date: Jun. 25, 2026

(54) Electrohydraulic Tool

(71) Applicant: Milwaukee Electric Tool Corporation, Brookfield, WI (US)

(72) Inventors: Justin K. Martin, West Bend, WI (US); Adam K. Sturgeon, Menomonee Falls, WI (US); John N. Reeve, Milwaukee, WI (US); Mathew R. Rentmeester, Brookfield, WI (US); Harrison T. Snyder, Milwaukee, WI (US); Jonathan G. Kriefall, Wauwatosa, WI (US)

(21) Appl. No.: 19/440,284

(22) Filed: Jan. 5, 2026

Related U.S. Application Data
(63) Continuation of application No. PCT/US2025/060656, filed on Dec. 19, 2025.
(60) Provisional application No. 63/737,353, filed on Dec. 20, 2024.
(60) Provisional application No. 63/796,842, filed on Apr. 29, 2025.
(60) Provisional application No. 63/838,221, filed on Jul. 3, 2025.

(51) Int. Cl. B25F 5/00

(52) U.S. Cl. CPC B25F 5/005

(57) ABSTRACT

Various embodiments of an electrohydraulic pressing tool are provided. The electrohydraulic tool includes a motor, a pump driven by the motor, a hydraulic cylinder, and a rotary valve. The hydraulic cylinder includes a hydraulic ram, an inlet, and an outlet. The pump is in fluid communication with the inlet of the hydraulic cylinder. When the motor is driven in a first rotational direction, the motor drives the pump to pump hydraulic fluid into the hydraulic cylinder to move the hydraulic ram from a retracted position to an extended position. When the motor is driven in a second rotational direction, the rotary valve is rotated from a closed position to an open position. Rotating the rotary valve to the open position allows hydraulic fluid to drain from the hydraulic cylinder through the outlet so that the hydraulic ram moves from the extended position to the retracted position.

### CROSS-REFERENCE TO RELATED APPLICATIONS

The present application is a continuation of International Application No. PCT/US2025/060656, filed Dec. 19, 2025, which claims the benefit of and priority to U.S. Provisional Application No. 63/838,221, filed on Jul. 3, 2025, to U.S. Provisional Application No. 63/737,353, filed on Dec. 20, 2024, and to U.S. Provisional Application No. 63/796,842, filed Apr. 29, 2025, each of which are incorporated herein in their entireties by reference thereto.

### BACKGROUND OF THE INVENTION

The present disclosure is directed generally to electrohydraulic tools and, in particular, to improvements to the electronic systems and hydraulic circuit of an electrohydraulic tool.

### SUMMARY OF THE INVENTION

Various embodiments of the invention relate to an electrohydraulic tool having improvements to various electronic and hydraulic systems. Advantageously, the improvements provide enhanced durability of the tool, improved user experience, and ease of manufacturability. The electrohydraulic tool can be configured for pressing fittings for plumbing applications, crimping electrical contacts or connections for electrical applications, or cutting wires, cables, or other conduits. In generally, the electrohydraulic tool includes a battery-powered motor that drives a pump to actuation a hydraulic cylinder. Depending on the type of tool head, the hydraulic cylinder may cause a pressing, crimping, or cutting action to take place, for example.

In a first aspect, embodiments of the present disclosure relate to an electrohydraulic tool. The electrohydraulic tool comprises a motor, a pump driven by the motor, a hydraulic cylinder, and a rotary valve. The hydraulic cylinder comprises a hydraulic ram, an inlet, and an outlet. The pump is in fluid communication with the inlet of the hydraulic cylinder. When the motor is driven in a first rotational direction, the motor drives the pump to pump hydraulic fluid into the hydraulic cylinder to move the hydraulic ram from a retracted position to an extended position. When the motor is driven in a second rotational direction opposite to the first rotational direction, the rotary valve is rotated from a closed position to an open position. Rotating the rotary valve to the open position allows hydraulic fluid to drain from the hydraulic cylinder through the outlet so that the hydraulic ram moves from the extended position to the retracted position.

In a second aspect, embodiments of the disclosure relate to the electrohydraulic tool of the first aspect in which the rotary valve is in fluid communication with the outlet of the hydraulic cylinder such that hydraulic fluid drains from the hydraulic cylinder through the rotary valve when the rotary valve is in the open position.

In a third aspect, embodiments of the disclosure relate to the electrohydraulic tool of the first aspect or the second aspect in which the electrohydraulic tool further comprises a release valve in fluid communication with the outlet of the hydraulic cylinder. When the rotary valve is in the closed position, the release valve is in a closed position such that hydraulic fluid cannot drain from the hydraulic cylinder through the release valve, and when the rotary valve is in an open position, the release valve is in an open position such that hydraulic fluid drains from the hydraulic cylinder through the release valve.

In a fourth aspect, embodiments of the present disclosure relate to the electrohydraulic tool of the third aspect in which a pilot line connects the pump and the rotary valve. In a closed position, hydraulic fluid on the pilot line is at a pilot pressure, and in an open position, hydraulic fluid on the pilot line is at a drain pressure. The release valve comprises a pilot port connected to the pilot line.

In a fifth aspect, embodiments of the present disclosure relate to the electrohydraulic tool of the fourth aspect in which the release valve comprises a valve body and a valve member. The valve body comprises an inlet port, an outlet port, the pilot port, and a valve seat disposed between the inlet port and the outlet port. The valve member is seated against the valve seat in the closed position of the release valve and is unseated from the valve seat in the open position of the release valve. A line pressure of hydraulic fluid between the outlet of hydraulic cylinder and the inlet port is less than the pilot pressure such that the pilot pressure is sufficient to keep the valve member seated against the valve seat.

In a sixth aspect, embodiments of the present disclosure relate to the electrohydraulic tool of the fifth aspect in which the release valve further comprises a plunger configured to manually actuate the valve member to unseat valve member from the valve seat when the plunger is pressed against the valve member.

In a seventh aspect, embodiments of the present disclosure relate to the electrohydraulic tool of the sixth aspect in which the plunger is spring-biased away from the valve member.

In an eighth aspect, embodiments of the present disclosure relate to the electrohydraulic tool of any of the first aspect to the seventh aspect in which the electrohydraulic tool further comprises a hydraulic fluid reservoir. The hydraulic cylinder comprises a first chamber, a second chamber, a piston, and a hydraulic ram. The piston separates the first chamber from the second chamber, and the hydraulic ram is mounted on the piston. The second chamber is connected to the hydraulic fluid reservoir by a return flow path such that the return flow path comprises at least a portion that is arranged concentrically with the hydraulic cylinder.

In a ninth aspect, embodiments of the present disclosure relate to the electrohydraulic tool of the eighth aspect in which the return flow path comprises a sleeve that is arranged concentrically outside the hydraulic cylinder.

In a tenth aspect, embodiments of the present disclosure relate to the electrohydraulic tool of the eighth aspect in which the hydraulic cylinder further comprises a post having a central flow passage. The piston and hydraulic ram translate within the hydraulic cylinder along the post, and at least one of the hydraulic ram or the piston comprises one or more openings to provide fluid communication between the second chamber and the central flow passage of the post.

In an eleventh aspect, embodiments of the present disclosure relate to the electrohydraulic tool of any of the first aspect to the tenth aspect in which the motor comprises a first driveshaft mechanically coupled to a gearbox transmission. The gearbox transmission is mechanically coupled to a first end of a second driveshaft configured to drive the pump, and the rotary valve is mechanically coupled to a second end of the second driveshaft opposite to the first end.

In a twelfth aspect, embodiments of the present disclosure relate to the electrohydraulic tool of the eleventh aspect in which the rotary valve is mechanically coupled to the second end of the second driveshaft with a one-way bearing such that the rotary valve does not rotate when the second driveshaft rotates in the first rotational direction and does rotate when the second driveshaft rotates in the second rotational direction.

In a thirteenth aspect, embodiments of the present disclosure relate to the electrohydraulic tool of the eleventh aspect or the twelfth aspect in which the gearbox transmission comprises a planetary gear system disposed within a gearbox housing. Within the gearbox housing, a ring gear of the planetary gear system is configured to rotate an arcuate distance from a first stop to a second stop, and upon contacting the second stop, the ring gear is fixed in place so that the planetary gear system is able to transfer rotation from the first driveshaft to the second driveshaft.

In a fourteenth aspect, embodiments of the present disclosure relate to the electrohydraulic tool of the thirteenth aspect in which the arcuate distance corresponds to rotation of from 20° to 170° within the gearbox housing.

In a fifteenth aspect, embodiments of the present disclosure relate to the electrohydraulic tool of the eleventh aspect in which the rotary valve comprises a first component and a second component. The second component is mechanically coupled to the second driveshaft, and one of the first component or the second component comprises an arcuate recess between a first stop and a second stop. The other of the first component or the second component comprises an arm member configured to travel within the arcuate recess from the first stop to the second stop such that, when the second driveshaft rotates in the second rotational direction, the arm member contacts the second stop to transfer rotation to the first component and move the rotary valve to the open position.

In a sixteenth aspect, embodiments of the present disclosure relate to the electrohydraulic tool of any of the first aspect to the fifteenth aspect in which the rotary valve is connected to an armature configured to reset the rotary valve to the closed position upon deactivation of the motor.

In a seventeenth aspect, embodiments of the present disclosure relate to an electrohydraulic tool. The electrohydraulic tool comprises a motor, a two-piece pump comprising a pump chamber and a pump mount, a hydraulic cylinder comprising a hydraulic ram, a fluid manifold disposed between the hydraulic cylinder and the pump, and a hydraulic fluid reservoir. The motor drives the two-piece pump to draw hydraulic fluid from the hydraulic fluid reservoir and pumps the hydraulic fluid into the hydraulic cylinder through the fluid manifold to move the hydraulic ram to an extended position. The pump chamber is joined to the pump mount with one or more pins that are held in place by the fluid manifold.

In an eighteenth aspect, embodiments of the present disclosure relate to the electrohydraulic tool of seventeenth aspect in which the pump chamber is comprised of a steel alloy and the pump mount is comprised of an aluminum alloy.

In a nineteenth aspect, embodiments of the present disclosure relate to the electrohydraulic tool of the seventeenth aspect or the eighteenth aspect in which the two-piece pump further comprises a plunger that is configured to reciprocate along a pump axis within the pump chamber. The pump chamber comprises an inlet arranged in line with the plunger along the pump axis, and a one-way check valve is disposed in the inlet to allow flow of the hydraulic fluid into the pump chamber through the inlet and prevents flow of the hydraulic fluid out of the pump chamber through the inlet.

In a twentieth aspect, embodiments of the present disclosure relate to the electrohydraulic tool of any of the seventeenth aspect to the nineteenth aspect in which the hydraulic fluid reservoir is disposed around the two-piece pump. The hydraulic fluid reservoir has a first end engaging the fluid manifold and a second end, opposite the first end, engaging the pump mount.

In a twenty-first aspect, embodiments of the present disclosure relate to an electrohydraulic tool. The electrohydraulic tool comprises an electrohydraulic drive system configured to drive a hydraulic ram within a hydraulic cylinder. A controller is configured to control the electrohydraulic drive system. A housing surrounds the electrohydraulic drive system, the hydraulic cylinder, and the controller. A clevis extends from a first end of the housing, and the clevis comprises a first clevis arm and a second clevis arm. A clevis pin is configured to be inserted into clevis to hold a working head between the first clevis arm and the second clevis arm. After inserting the clevis pin into the clevis, the clevis pin is configured to be rotated from an unlocked position in which the clevis pin can be withdrawn from the clevis to a locked position in which the clevis pin cannot be withdrawn from the clevis. The first clevis arm comprises a first sensor in communication with the controller, and the clevis pin comprises a flag configured to be detected by the sensor when the clevis pin is in the locked position. The controller only activates the electrohydraulic drive system after the sensor detects the flag of the clevis pin in the locked position.

In a twenty-second aspect, embodiments of the present disclosure relate to the electrohydraulic tool of the twenty-first aspect in which the flag comprises a magnet and in which the sensor is a Hall effect sensor.

In a twenty-third aspect, embodiments of the present disclosure relate to the electrohydraulic tool of the twenty-first aspect or the twenty-second aspect in which the hydraulic ram has a retracted position and an extended position. The second clevis arm comprises a second sensor in communication with the controller, and the second sensor is configured to detect a distal end of the hydraulic ram as the hydraulic ram is retracted from the extended position toward the retracted position. Upon sensing the distal end of the hydraulic ram by the sensor, the controller stops retraction of the hydraulic arm at an intermediate position between the extended position and the retracted position.

In a twenty-fourth aspect, embodiments of the present disclosure relate to the electrohydraulic tool of the twenty-third aspect in which the electrohydraulic tool further comprises a selector switch. The selector switch is configured to be toggled between a first stetting and a second setting. The first setting causes the hydraulic ram to retract to the retracted position, and the second setting causes the hydraulic ram to retract to the intermediate position.

In a twenty-fifth aspect, embodiments of the present disclosure relate to the electrohydraulic tool of any of the twenty-first aspect to the twenty-fourth aspect in which the housing comprises a collar surrounding the clevis. The collar comprises a first surface disposed in a plane angled relative to a longitudinal axis of the electrohydraulic tool. A plurality of RGB LED lights are disposed in the first surface, and the controller is configured to cause the plurality of RGB LED lights to illuminate or blink for a particular time and in a particular color to indicate a stage of operation or a result of operation of the electrohydraulic tool.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIGS. 1A-1C depict electrohydraulic tools according to exemplary embodiments of the present disclosure;

FIGS. 2A and 2B depict schematic diagrams of the electronic and hydraulic systems of the electrohydraulic tool, according to exemplary embodiments of the present disclosure;

FIG. 3A depicts a cross-sectional view of the electrohydraulic tool according to the schematic diagram shown in FIG. 2A, according to an exemplary embodiment of the present disclosure;

FIGS. 3B and 3C depict a cross-sectional view of the electrohydraulic tool according to the schematic diagram shown in FIG. 2B, according to an exemplary embodiment of the present disclosure;

FIG. 4 depicts a first embodiment of a hydraulic cylinder of the electrohydraulic tool, according to an exemplary embodiment of the present disclosure;

FIG. 5 depicts a second embodiment of a hydraulic cylinder of the electrohydraulic tool, according to an exemplary embodiment of the present disclosure;

FIGS. 6A-6B and 6C-6D depict two embodiments a two-piece pump assembled using pins, according to an exemplary embodiment of the present disclosure;

FIG. 7 depicts a pump having a check valve integrated into the piston bore of the pump, according to an exemplary embodiment of the present disclosure;

FIGS. 8A and 8B depict a system for detecting a roller carrier in a clevis for coordinating a short stroke of the press tool, according to an exemplary embodiment of the present disclosure;

FIGS. 9A-9C depict a system for detecting proper installation of a clevis pin in the clevis of the press tool, according to an exemplary embodiment of the present disclosure;

FIGS. 10A-10C depict LED lights provided on a housing of the press tool for illumination and for communication with the user, according to an exemplary embodiment of the present disclosure;

FIGS. 11A and 11B depict a mounting sled for electronic components to facilitate assembly and organization of components within the press tool, according to an exemplary embodiment of the present disclosure;

FIG. 12 depicts an embodiment of the return valve in the form of a shear seal valve actuated using a one-way bearing, according to an exemplary embodiment of the present disclosure;

FIG. 13 depicts another embodiment of the hydraulic cylinder in which the endcap has two pieces and the pressure relief valve is incorporated into the hydraulic ram, according to an exemplary embodiment of the present disclosure;

FIG. 14 depicts a gearbox transmission of the electrohydraulic tool, according to an exemplary embodiment of the present disclosure;

FIG. 15 depicts the gearbox transmission configured to allow free-spinning of a ring gear of a planetary gear system, according to an exemplary embodiment of the present disclosure; and

FIG. 16 depicts a two-component return valve configured to allow for free-spinning before engaging to open an inlet, according to an exemplary embodiment of the present disclosure.

### DETAILED DESCRIPTION

Referring generally to the figures, various embodiments of an electrohydraulic tool are provided according to the present disclosure. As will be discussed more fully below, an electrohydraulic tool is a device that utilizes a battery-powered motor connected to a hydraulic circuit to drive a ram, which closes tool head, and the tool head, either directly or through an intermediary device, carries out a pressing, crimping, or cutting action. For example, the electrohydraulic tool may be a press tool having a press jaw tool head in which the press jaw compresses a fitting around a conduit, such as copper pipe. In this way, the fitting compressed around the conduit provides a fluidtight connection between sections of conduit. Advantageously, the use of a press tool with such fittings allows for connections between sections of conduit without the need for soldering, which requires significant surface preparation steps and produces undesirable fumes. In another example, the electrohydraulic tool may be a crimper having a crimping jaw configured to attach an electrical connector to the end of a conductor, or the electrohydraulic tool may be a cutter having a cutting jaw configured to shear a section of wire, rebar, cable, or other conduit.

According to embodiments of the present disclosure, various improvements to such an electrohydraulic tool are provided herein. In particular, embodiments of the present disclosure relate to improvements to the return flow path of the hydraulic cylinder, to the hydraulic pump that provides hydraulic fluid to the hydraulic cylinder, to the user interface for operating the electrohydraulic tool, and to the electronic control of the electrohydraulic tool, amongst others. These improvements enhance the reliability, safety, and user experience of a pressing, crimping, or cutting operation using the electrohydraulic tool. These and other aspects and advantages will be described more fully below in relation to the embodiments disclosed herein and shown in the drawings. The embodiments are provided by way of illustration and not limitation.

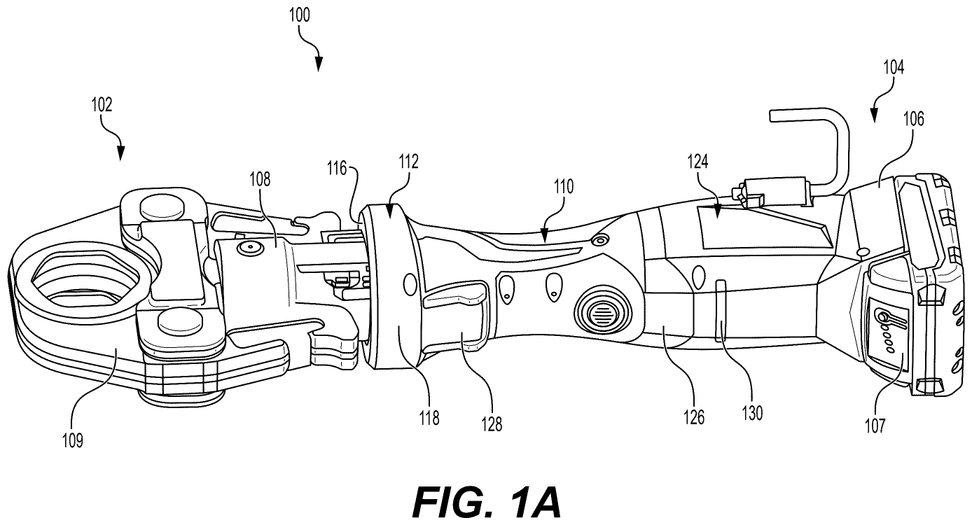

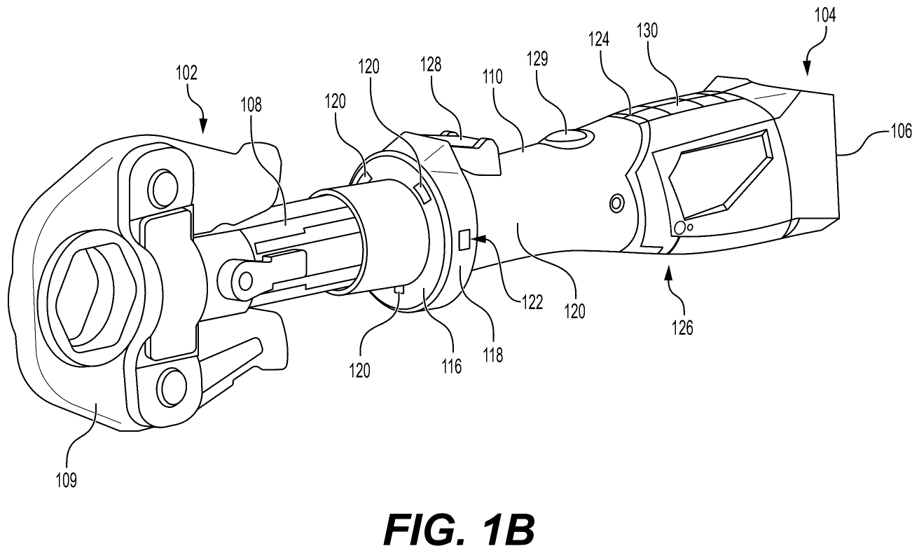

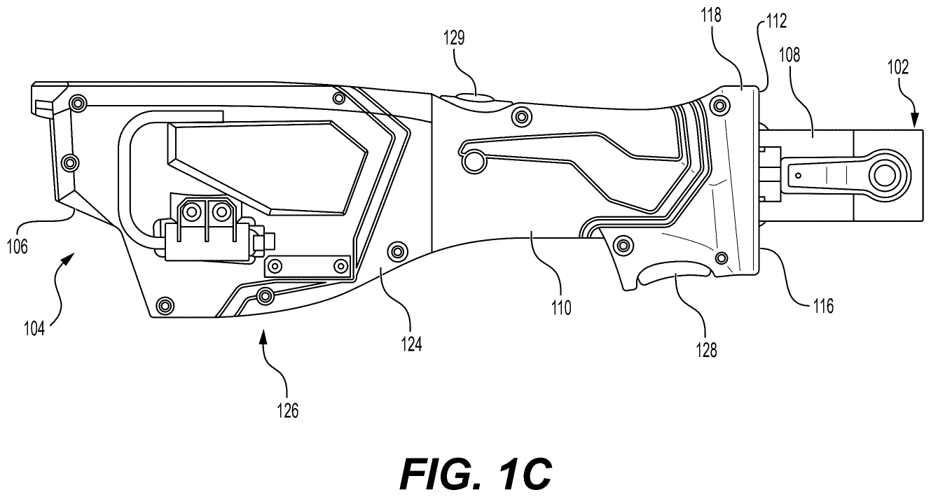

FIGS. 1A-1C depict electrohydraulic tools 100 according to exemplary embodiments. The tool 100 has a first end 102 and a second end 104. The second end 104 defines a receptacle 106 for a battery 107 to power the tool 100. Disposed at the first end 102 of the tool is a clevis 108 configured to hold a tool head 109 (as shown in FIG. 1A), such as a press jaw for compressing a fitting, a cutting jaw for cutting, e.g., wire or cable, a crimping jaw for crimping an electrical connector, etc. In FIG. 1A, the tool head 109 is a press jaw. Disposed between the first end 102 and the second end 104 is a handle section 110, and disposed between the handle section 110 and the clevis 108 is a collar 112.

In one or more embodiments, the collar 112 defines a first surface 116 facing toward the first end 102 and a second surface 118 angled relative to the first surface 116, in particular perpendicular to the first surface 116. According to embodiments of the present disclosure, most clearly depicted in FIG. 1B, the tool 100 includes a plurality of LED 120, in particular RGB LED, disposed in the first surface 116. As will be discussed more fully below, the LED 120 can be used as indicators of a successful/failed pressing operation, indication of a working mode (e.g., blue, yellow, red, green, etc.), and/or provide lighting for a pressing operation. Further, in one or more embodiments, a selector switch 122 (as shown in FIG. 1B) is mounted on the second surface 118, and the selector switch 122 allows a user to select between a plurality of hydraulic ram positions. In one or more embodiments, the user is able to select between at least a long stroke and a short stroke of the hydraulic ram using the selector switch 122.

The collar 112 and handle section 110 together with an end section 124 define a housing 126 of the tool 100. Disposed within the housing 126 are the electronic and hydraulic components that carry out a pressing operation. In particular, in one or more embodiments, the end section 124 of the housing 126 contains the electric motor, the hydraulic pump, reservoir, and control components of the tool 100, and the handle section 110 contains the hydraulic cylinder with the ram that drives the press jaws.

In one or more embodiments, the housing 126 includes an actuation button 128 disposed at an end of the handle section 110 or on the end section 124. In the embodiments depicted in FIGS. 1A-1C, the actuation button 128 is a trigger positioned adjacent the collar 112. In operation, according to one or more embodiments, the user presses the actuation button 128 until a predetermined set pressure is reached at which point the tool 100 will automatically complete the pressing operation. In one or more other embodiments, upon pressing the actuation button 128, the hydraulic ram automatically fully extends and closes the press jaw to complete the pressing action. In one or more embodiments, after the hydraulic ram is extended, the tool 100 automatically retracts the hydraulic ram, and the user does not have to continue pressing the actuation button 128. Additionally, in one or more other embodiments, the electrohydraulic tool 100 may include a manual release button 129 to cause retraction hydraulic ram if the battery of the electrohydraulic tool 100 loses charge during an operation.

In one or more embodiments, the end section 124 may comprise a further LED 130, shown as an LED bar, which may be used to communicate information to the user.

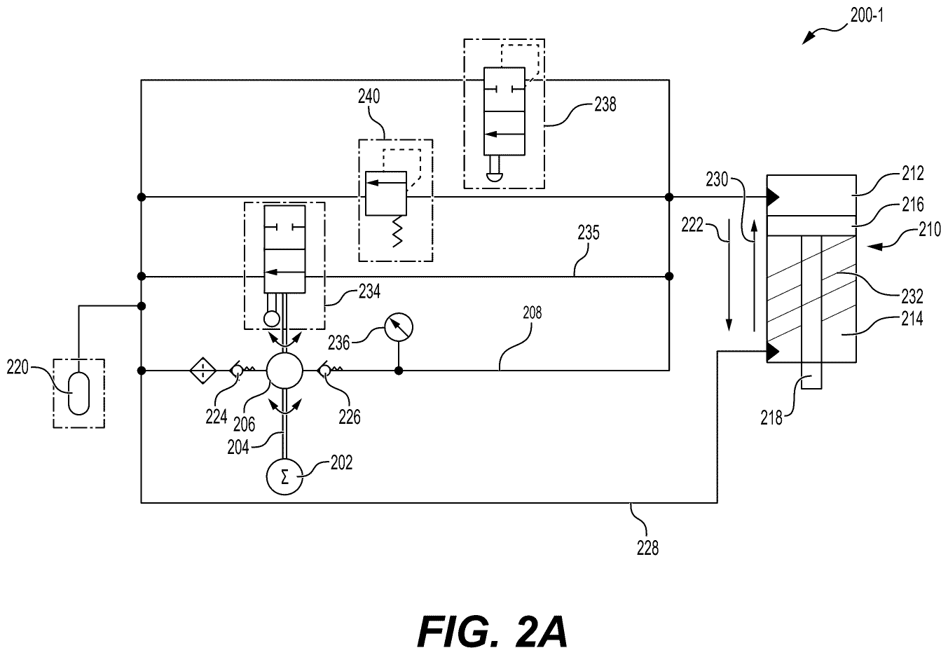

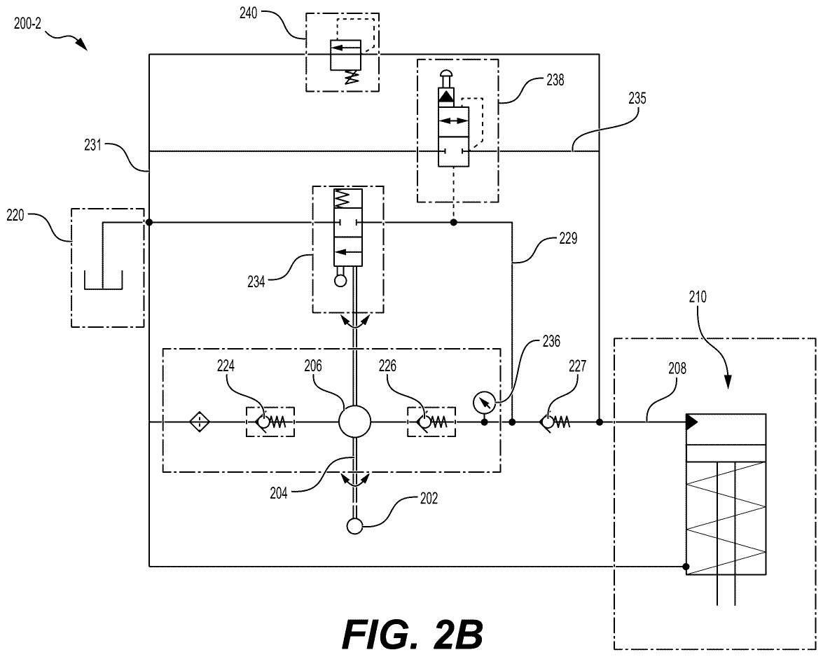

FIG. 2A is a first schematic diagram 200-1 of the electronic and hydraulic components of the tool 100, representing a first exemplary embodiment of a configuration of the components in the tool. In particular, the first schematic diagram 200-1 of FIG. 2A includes a motor 202 with a drivetrain 204 coupled to a pump 206, which may collectively be referred to as an “electrohydraulic drive system.” The pump 206 produces flow on a first line 208 in fluid communication with a hydraulic cylinder 210. The hydraulic cylinder 210 includes a first chamber 212 and a second chamber 214 separated by a piston 216. A hydraulic ram 218 is mounted to the piston 216, which is the same hydraulic ram that drives the press jaws as discussed above.

During operation, the pump 206 draws hydraulic fluid from a reservoir 220, which may, for example, be a flexible bladder, and provides fluid at a continuous flow rate on the first line 208 to the first chamber 212 of the hydraulic cylinder 210. This increases the pressure in the first chamber 212, driving the piston 216 in a first direction 222, which increases the volume of the first chamber 212 and decreases the volume of the second chamber 214.

As shown in FIG. 2A, flow into and out of the pump 206 is controlled by a first check valve 224 and a second check valve 226. The first check valve 224 is disposed between the reservoir 220 and the pump 206, and the second check valve 226 is disposed between the pump 206 and the hydraulic cylinder 210. When hydraulic fluid is drawn into the pump 206 from the reservoir 220, the first check valve 224 is open, and the second check valve 226 is closed such that fluid can only be drawn into the pump 206 from the reservoir 220 and not from the first line 208 or hydraulic cylinder 210. When the pump 206 expels the hydraulic fluid onto the first line 208, the second check valve 226 is open, and the first check valve is closed 224 such that fluid cannot be expelled back to the reservoir 220 and is only expelled to the hydraulic cylinder 210. As will be discussed more fully below, embodiments of the present disclosure relate to a pump 206 in which the first check valve 224 is incorporated into an inlet of the pump 206.

The motor 202 drives the pump 206 until completion of the pressing action. This causes the second chamber 214 of the hydraulic cylinder 210 to expel hydraulic fluid through an outlet of the hydraulic cylinder 210 onto a return line 228 in fluid communication with the reservoir 220. After the pressing action is complete, the hydraulic cylinder 210 returns the hydraulic ram 218 to a starting position by driving the hydraulic ram 218 in a second direction 230 that is opposite to the first direction 222 using a spring 232, which may be a compression and/or extension spring. That is, the spring 232 is disposed in the hydraulic cylinder 210 and biases the piston 216 in the second direction 230. During the pressing action, the motor 202 drives the pump 206, which causes fluid to accumulate in the first chamber 212, overcoming the bias of the spring 232. Upon completion of the pressing action, the motor 202 stops driving the pump 206, and a return valve 234 is opened to allow hydraulic fluid to drain from the hydraulic cylinder 210. In one or more embodiments, the return valve 234 is a rotary valve, such as a shear seal valve. In one or more embodiments, the return valve 234, in the form of a rotary valve, is opened by rotating the motor 202 in a rotational direction opposite to the rotational direction to drive the pump. However, in one or more other embodiments, the return valve 234 can be actuated in other ways. Once the return valve 234 is opened, the spring 232 drives the piston 216 in the second direction 230 such that the hydraulic fluid can drain on a second line 235 through the return valve 234 back to the reservoir 220.

Determination of completion of the pressing action is done using a pressure transducer 236. The pressure transducer 236 measures the pressure on the first line 208, and once that pressure reaches a predetermined threshold, the tool 100 determines that the pressing action has been completed. A signal is sent to the motor 202 to stop driving the pump 206 and to open the return valve 234.

As shown in FIG. 2A, the tool 100 may include two additional valves to return fluid to the reservoir 220. In one or more embodiments, the tool 100 includes a manual release valve 238. The manual release valve 238 allows for the hydraulic ram 218 to return to the starting position even if the motor 202 cannot complete the pressing action or open the return valve 234, such as if the battery is discharged below a minimum operating parameter during operation. In such instance, the manual release valve 238 allows the user to manually open a valve to allow hydraulic fluid to drain from the first chamber 212 of the hydraulic cylinder 210 back to the reservoir 220 so that the spring 232 can return the piston 216 to the starting position. This causes the hydraulic ram 218 to withdraw so that the press jaws can be released. The manual release valve 238 may be a check valve actuated by a button mounted to the housing of the tool. The button may include a plunger that presses against a ball of the check valve to unseat the ball from a passage, allowing the flow of fluid through the check valve. In another embodiment, the manual release valve 238 may be integrated with the return valve 234 such that the manual release valve 238 comprises an actuator configured to manually open the return valve 234 such that fluid returns on the same line (second line 235) as the return valve 234.

In one or more embodiments, the tool 100 also includes an emergency pressure relief valve 240. According to the present disclosure, the emergency pressure relief valve 240 is preferably not ever used during operation of the tool 100. The emergency pressure relief valve 240 is provided for an overpressure incident. That is, the tool may potentially experience some issue that causes the pressure to increase beyond the desired pressure threshold for performing a successful pressing operation. If the pressure were allowed to increase unchecked, then the tool could experience a catastrophic failure. Thus, the emergency pressure relief valve 240 is designed to open at a pressure above the operating pressure threshold and below a catastrophic pressure. As shown in FIG. 2A, when opened, the emergency pressure relief valve 240 allows for the return of hydraulic fluid to the reservoir 220 from the first chamber 212 of the hydraulic cylinder 210. In one or more embodiments, the pressure relief valve 240 is incorporated in the piston 216 or hydraulic ram 218. In one or more embodiments, the pressure relief valve 240 is a check valve with a spring-biased ball that is seated in a flow path of the pressure relief valve 240. In such embodiments, the spring-biasing is selected to open above the operating pressure threshold but below the catastrophic pressure as mentioned above.

FIG. 2B depicts a second schematic diagram 200-2 of the electronic and hydraulic components of the tool 100, representing a second exemplary embodiment of a configuration of the components in the tool. As with the previous embodiment, the diagram 200-2 of FIG. 2B includes the motor 202 with the drivetrain 204 coupled to the pump 206, which produces flow on the first line 208 in fluid communication with the hydraulic cylinder 210. Flow into and out of the pump 206 is still controlled by the first check valve 224 and the second check valve 226, but a third check valve 227 is disposed on the first line 208. Disposed between the second check valve 226 and the third check valve 227 is a pilot line 229 as well as the pressure transducer 236. The third check valve 227 isolates the pilot line 229 from the hydraulic cylinder 210.

The return valve 234 controls flow from the pilot line 229 to a drain line 231. In particular, when the return valve 234 is closed, fluid communication between the pilot line 229 and the drain line 231 is prevented, and when the return valve 234 is open, fluid communication is provided between the pilot line 229 and the drain line 231. As can be seen, the pilot line 229 is also in fluid communication with the manual release valve 238. The manual release valve 238 controls flow from the hydraulic cylinder 210 to the reservoir 220 on the return line 228. As will be discussed more fully below, the manual release valve 238 includes a valve member that is positioned depending on the pressure in the pilot line 229. In particular, when the return valve 234 is closed, the pressure in the pilot line 229 closes the valve member of the manual release valve 238, preventing return of hydraulic fluid on the second line 235 through the manual release valve 238. When the return valve 234 is open so that the pilot line 229 is connected to the drain line 231, the pressure in the pilot line 229 is decreased such that the valve member of the manual release valve 238 opens, allowing for hydraulic fluid to drain from the hydraulic cylinder 210 on the second line 235. Thus, in one or more embodiments, the manual release valve 238 may also be referred to as a pilot-operated manual release valve 238. This valve is also described as being a manual release valve because it contains a plunger that can be manually actuated to move the valve member to the open position against the pressure in the pilot line 229 (e.g., if the battery is discharged during operation). Further, as described above, the schematic diagram 200-2 also includes an emergency pressure relief valve 240 to prevent a catastrophic failure of the tool 100.

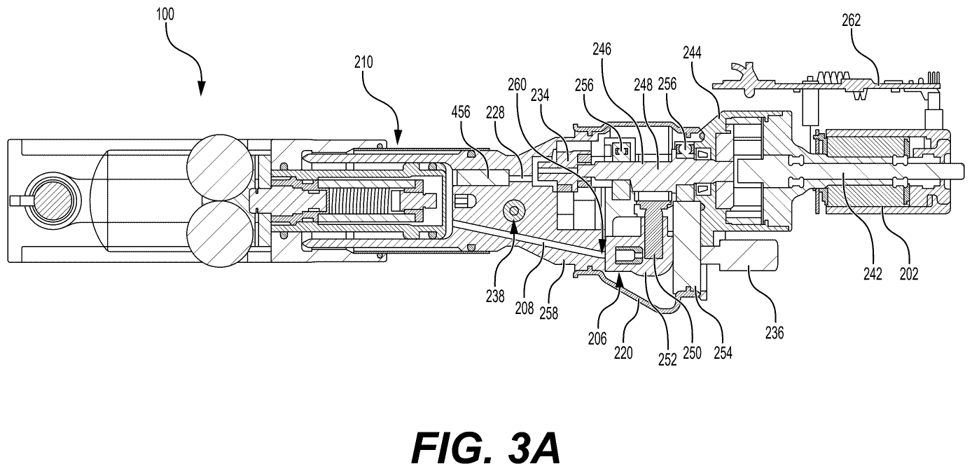

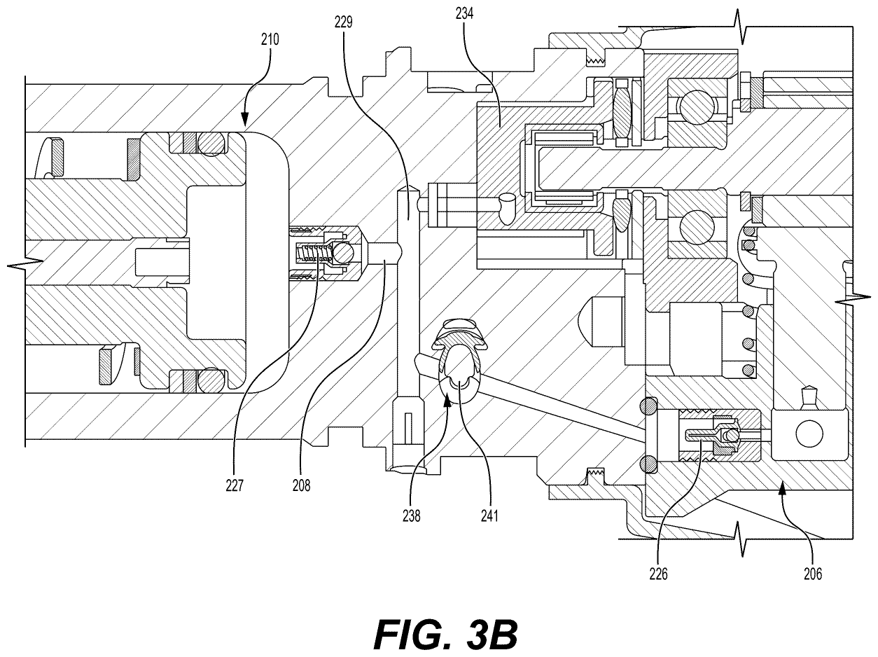

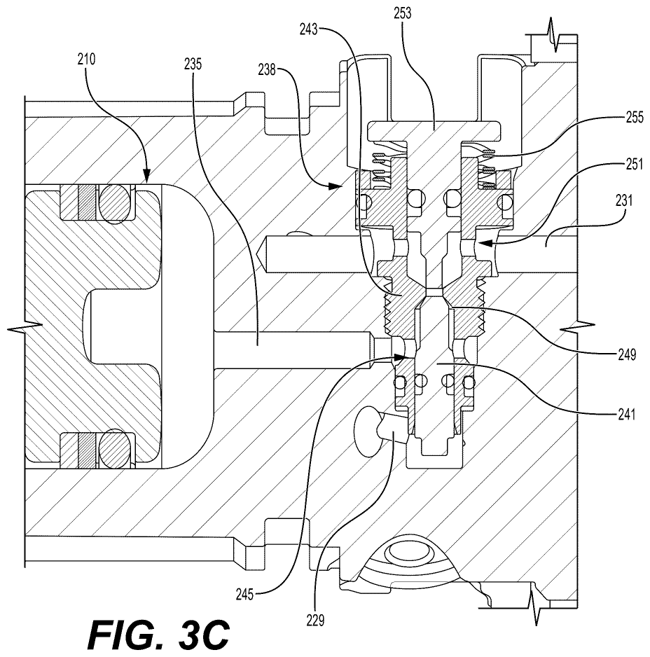

FIG. 3A depicts the physical layout of the electronic and hydraulic components within the housing 126 (not shown) of the tool 100 according to the schematic of FIG. 2A. Starting on the right side of FIG. 3A, the motor 202 is shown with a first driveshaft 242 coupled to a gearbox 244. In one or more embodiments, the motor 202 is an outer rotor motor. In one or more embodiments, the gearbox 244 is a planetary gearbox providing a gear ratio of, e.g., 6:1. The gearbox 244 is coupled to a second driveshaft 246. The second driveshaft 246 includes a cam lobe 248, and rotation of the second driveshaft 246 causes the cam lobe 248 to reciprocate a plunger 250 of the pump 206, which is, in particular, a piston pump. In one or more embodiments, the pump 206 is a two-piece pump, including a pump chamber 252 and a pump mount 254. The plunger 250 reciprocates within the pump chamber 252. As can be seen in FIG. 3A, the second driveshaft 246 extends through the pump mount 254, being held in place by bearings 256, and the pump mount 254 positions the second driveshaft 246 such that the cam lobe 248 is disposed over the plunger 250.

As can be seen in FIG. 3A, the pump 206 is disposed within the reservoir 220. In particular, one end of the reservoir 220 is attached to a rim of the pump mount 254, and the other end of the reservoir 220 is mounted to an internal manifold 258 of the tool 100. The first line 208 extends through the internal manifold 258 and provides fluid communication between an outlet 260 of the pump 206 and the first chamber 212 of the hydraulic cylinder 210. The hydraulic cylinder 210 will be discussed in more detail below. As shown in FIG. 3A, though, the hydraulic cylinder 210 is also in fluid communication with the return line 228. Fluid communication between the return line 228 and the reservoir 220 is controlled by the return valve 234.

As mentioned above, control of the motor 202 and return valve 234 is based on whether a pressure threshold is reached as measured by the pressure transducer 236. As shown in FIG. 3A, the pressure transducer 236 is mounted to the pump chamber 252 to measure the pressure in the first line 208. The pressure transducer 236 is in electrical communication with a controller of a PCBA 262, which is in electrical communication with the motor 202 to actuate the motor 202. The controller may be any of a variety of suitable controllers known in the art, such as a general purpose single-or multi-chip processor, a central processing unit (CPU), a digital signal processor (DSP), an applications processor, an application specific integrated circuit (ASIC), a field programmable gate array (FPGA) or other programmable logic device (PLD), discrete gate or transistor logic, discrete hardware components, or any combination thereof designed to perform the functions and operations described herein.

Stopping the motor 202 will cause the pump 206 to also stop, but in one or more embodiments, counter rotating of the motor 202 is performed to open the return valve 234 when in the form of a rotary valve. In such embodiments and as shown in FIG. 3A, the return valve 234 is coupled to an end of the second driveshaft 246 such that the counter rotation of the motor 202 drives counter rotation of the second driveshaft 246 to open the return valve 234. In one or more embodiments, the second driveshaft 246 rotates about 45° to open the return valve 234. As such the motor 202 is not driven long to open the return valve 234.

FIGS. 3B and 3C depict the valve arrangement for controlling the flow of hydraulic fluid to and from the hydraulic cylinder 210 according to the second schematic diagram 200-2 of FIG. 2B. As can be seen, the pump 206 directs fluid through the second check valve 226 onto the first line 208, which is in fluid communication with the pilot line 229. The third check valve 227 allows for flow of hydraulic fluid into the hydraulic cylinder 210 but does not allow return flow from the hydraulic cylinder 210 to the pilot line 229. The pilot line 229 is in fluid communication on one end with the return valve 234 and with a valve member 241 of the manual release valve 238 on the other end.

As can be seen from FIGS. 3B and 3C, the valve member 241 is disposed within a valve body 243 having an inlet port 245 in fluid communication with the hydraulic cylinder 210 to provide drain flow. Within the valve body 243, the valve member 241 is abutted against a valve seat 249 when the return valve 234 is closed. In particular, the pressure on the pilot line 229 when the return valve 234 is closed holds the valve member 241 in the closed position against the valve seat 249. This blocks of flow of hydraulic fluid through the valve body 243 to an outlet port 251 in fluid communication with the return line 228. However, when the return valve 234 is opened, the pressure on the pilot line 229 drops, allowing the pressure from the hydraulic fluid in the hydraulic cylinder 210 to unseat the valve member 241 from the valve seat 249. In this way, fluid communication is provided between the inlet port 245 and the outlet port 251 so that the hydraulic cylinder 210 can drain.

As mentioned above, the manual release valve 238 includes a plunger 253 configured to be manually actuated to unseat the valve member 241. From FIGS. 3B and 3C, it can be seen that the plunger 253 can be biased away from the valve member 241 with a spring 255. In this way, a user presses on the plunger 253 like a button in order to manually actuate the manual release valve 238. In one or more embodiments, the user may press directly along the axis of the plunger 253; however, in one or more other embodiments, the plunger 253 may be acted upon by a lever having an end in mechanical communication with a push button 257.

With respect to the embodiments described hereinabove, including in relation to FIGS. 2B and 3B-3C, when the motor 202 drives the second driveshaft 246 to rotate opposite to the actuation direction, the return valve 234 is opened to drain the hydraulic cylinder 210. Because the return valve 234 is opened when the electrohydraulic tool is fully pressurized, Applicant has been found that the motor 202 is required to initiate opening of the return valve 234 under a heavy load, causing a large current in-rush to the motor 202 that could affect the electronic systems of the electrohydraulic tool and could potentially damage the tool battery.

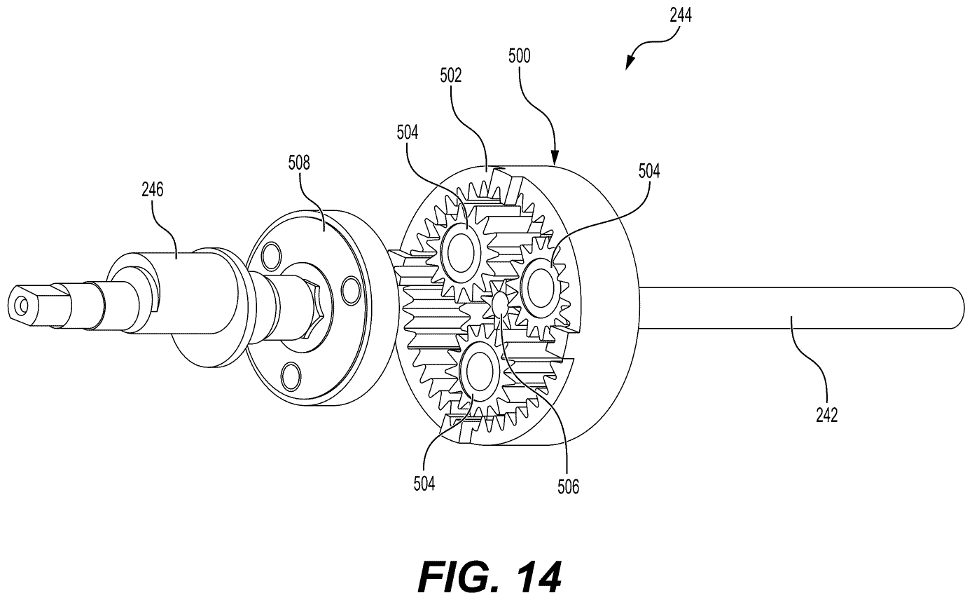

To address the issue of current inrush, in one or more embodiments, the gearbox 244 is allowed to spin freely for an arcuate distance, which allows the motor 202 to build up angular momentum before actuating the return valve 234 through the second driveshaft 246. As shown in FIG. 14, the gearbox 244 includes a planetary gear system 500 with a ring gear 502, planetary gears 504, and a sun gear 506. The sun gear 506 is connected to the first driveshaft 242 of the motor 202, and the sun gear 506 transfers rotational motion of the first driveshaft 242 to the planetary gears 504. The planetary gears 504 are held on a planet carrier 508, which is connected to the second driveshaft 246. In this way, when the ring gear 502 is held fixed, the planetary gears 504 rotate within the ring gear 502 to transfer rotational motion from the sun gear 506 connected to the first driveshaft 242 to the second driveshaft 246 through the planet carrier 508.

If the ring gear 502 is not held fixed, however, no rotational motion is transferred to the second driveshaft 246, and the return valve 234 is not opened. Notwithstanding, the motor 202 and the first driveshaft 242 are able to build up rotational momentum without experiencing a sudden inrush of current that may otherwise occur if the motor 202 were forced to open the return valve 234 in the fully pressurized condition from a dead stop.

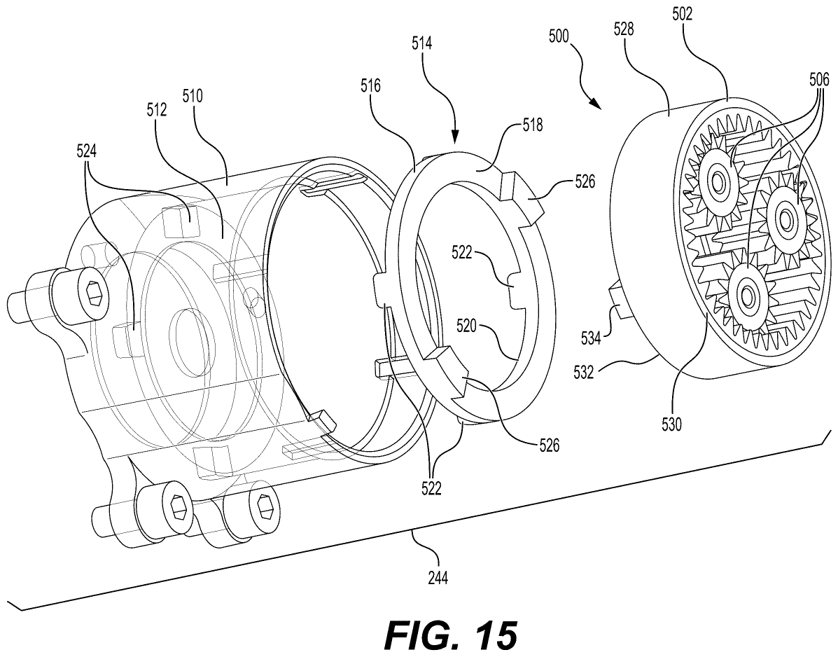

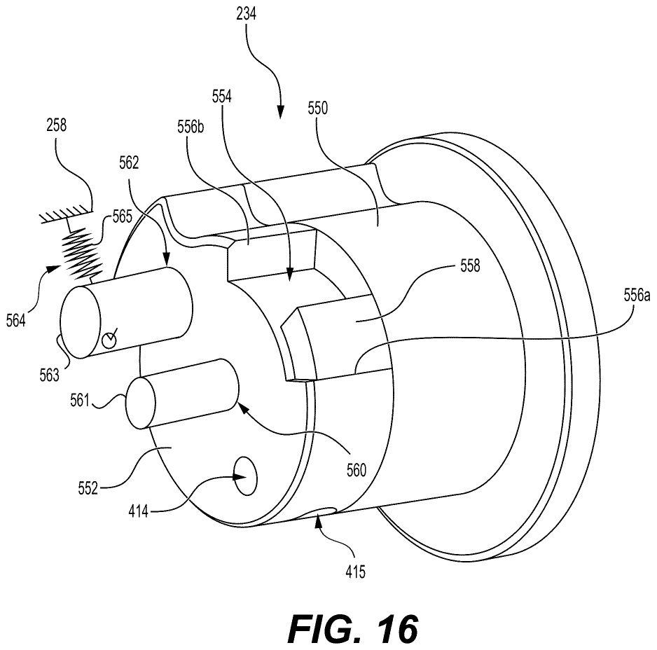

The gearbox 244 according to one or more embodiments is shown in an exploded view in FIG. 15. As can be seen, the gearbox 244 includes a gearbox housing 510 (shown with interior lines to better illustration its structure) having a seat 512 configured to receive the planetary gear system 500. In one or more embodiments, a ring stop 514 is disposed between the seat 512 and the planetary gear system 500. In one or more embodiments, the ring stop 514 includes an annular band 516 having a first major surface 518 and a second major surface 520 in which the second major surface 520 is opposite to the first major surface 518. One or more mounting inserts 522 extend from the second major surface 520. The mounting inserts 522 are configured to engage pockets 524 formed in the seat 512 to hold the ring stop 514 within the gearbox housing 510. On the opposite side, one or more stops 526 extend from the first major surface 518.

In one or more embodiments, the ring gear 502 of the planetary gear system 500 includes a cylindrical wall 528 with a first surface 530 and a second surface 532. At least one finger 534 extends from the second surface 532 of the ring gear 502 toward the ring stop 514. Further, when the ring stop 514 and ring gear 502 are seated within the gearbox housing 510, the second surface 532 of the cylindrical wall 528 of the ring gear 502 rests on the stops 526 of the ring stop 514, and the at least one finger 534 is configured to rotate over the first major surface 518 of the ring stop 514 between the stops 526. In this way, when the motor 202 rotates the first driveshaft 242, the ring gear 502 rotates with the sun gear 506 and planetary gears 504 (i.e., spins freely as mentioned above) until the at least one finger 534 engage respective stops 526 on the ring stop 514. Upon engaging the stops 526, the ring gear 502 becomes fixed in the direction of rotation, and the planetary gears 504 can then transfer rotational motion to the planet carrier 508 and the second driveshaft 246. In this way, the motor 202 can rotate for a plurality of spins, building up angular momentum, before the motor 202 is forced to engage the load associated with opening the return valve 234.

Advantageously, the motor 202 thus does not experience a large inrush of current necessary to rotate against the highly pressurized load on the return valve 234. In investigating the problem of current inrush, Applicant found that inrush currents as high as 79 amps were possible in conventional designs, and the motor 202 routinely experienced currents above 50 amps. Upon implementation of the presently disclosed gearbox 244 in which the ring gear 502 was able to spin freely for an arcuate distance, the motor 202 experienced a maximum current inrush of 33 amps, which was well within normal operation mode of the motor 202. Additionally, by keeping current inrush low, power was not pulled from other electrical systems in the electrohydraulic tool, and damage to the battery was avoided.

In one or more embodiments, the at least one finger 534 and the at least one stop 526 are arranged such that the ring gear 502 is able to rotate from 20° to 170°, in particular about 50°, before the ring gear 502 is fixed in place.

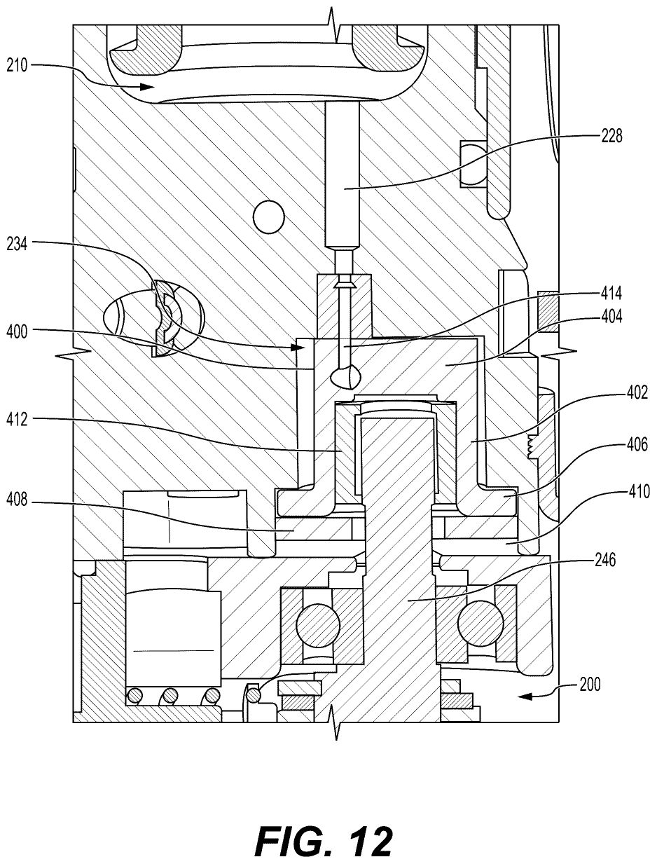

While the free-spinning of the ring gear 502 is primarily designed to address opening of the return valve 234, the free-spinning of the ring gear 502 also provides benefits during closing of the return valve 234 when actuating the system. In particular, besides preventing large current inrush for the actuating condition as well, Applicant has found that return valve 234 position sensing has greater fidelity because of enhanced Hall tick transitions. Further, the presently disclosed design of the gearbox 244 is particularly suitable for designs of the electrohydraulic tool in which the return valve 234 is directly actuated by the second driveshaft 246, such as discussed below in relation to FIG. 12.

In one or more embodiments, the return valve 234 is coupled to the second driveshaft 246 using a one-way bearing, such as shown in FIG. 12. In one or more such embodiments, the return valve 234 is a rotary valve, in particular a shear seal valve. As shown in FIG. 12, the return valve 234 includes valve head 400 having a peripheral wall 402 and a top wall 404. Extending from the bottom of the peripheral wall 402 is a flange 406. In one or more embodiments, the flange 406 sits on a thrust bearing 408, which sits on a washer 410. Disposed within the peripheral wall 402 is a one-way bearing 412, such as a roller bearing. The one-way bearing 412 is coupled to the end of the second driveshaft 246. The one-way bearing 412 allows the end of the second driveshaft 246 to spin freely when the motor 202 drives the second driveshaft 246 in the pressurizing direction, but when the motor 202 drives the second driveshaft 246 in the opposite direction, the one-way bearing 412 engages the driveshaft 246 and causes the valve head 400 to rotate. In one or more embodiments, the valve head 400 rotates approximately 45° between the open and closed positions. Prior to rotation of the valve head 400, the inlet 414 of the valve head 400 is sealed against an interior surface of the manifold 258, and the return line 228 is blocked off by the top wall 404 of the valve head 400. The rotation of the valve head 400 causes the inlet 414 of the valve head 400 to align with the return line 228 from the hydraulic cylinder 210 (as shown in FIG. 12). A bore extends through the top wall 404 of the valve head 400 from the inlet 414 to an outlet 415 (shown in FIG. 16) in the peripheral wall 402 of the valve head 400. In this way, hydraulic fluid from the hydraulic cylinder 210 drains through the return line 228 into the valve head 400 and into the reservoir 220.

As mentioned above, current inrush to the motor 202 is a more pronounced issue when the return valve 234 is directly driven by the second driveshaft 246 (e.g., as shown in FIG. 12). One way to address current inrush, as discussed is to allow free spinning of the ring gear 502 of the gearbox transmission 244. However, another manner of addressing current inrush is to allow the return valve 234 to spin freely for an arcuate distance before opening the inlet 414. FIG. 16 depicts an embodiment of a return valve 234 having a first component 550 and a second component 552. In one or more embodiments, the first component 550 is connected to the second driveshaft 246 and is directly rotated by the second driveshaft 246 as described above in relation to FIG. 12.

In one or more embodiments, the second component 552 includes an arcuate recess 554 having a first stop 556a and a second stop 556b disposed at opposite ends of the recess 554. The first component 550 includes an arm member 558 configured to travel within the recess 554 between the first stop 556a and the second stop 556b. In this way, the initial rotation of the second driveshaft 246 is transferred to the first component 550 but not to the second component 552 until the arm member 558 contacts the opposing stop 556a, 556b. That is, if the arm member 558 initially rests against the first stop 556a, the second driveshaft 246 rotates the first component 550 until the arm member 558 contacts the second stop 556b of the second component 552, fixing the first component 550 relative to the second component 552 such that the first component 550 can act on the second component 552.

In this way, continued rotation of the second driveshaft 246 will cause the return valve 234 to align the inlet 414 with the return line 228 connected to the hydraulic cylinder 210. As with the free-spinning of the ring gear 502 described in relation to FIGS. 14 and 15, the free-spinning of the first component 550 of the return valve 234 (e.g., over an angle in the range of 20° to 170°) allows for the motor 202 to build up angular momentum before the motor 202 opens the return valve 234.

In one or more embodiments, the return valve 234 (whether single component as shown in relation to FIG. 12 or two component as shown in relation to FIG. 16) includes a central recess 560. The central recess 560 is configured to receive a spindle 561 about which the return valve 234 is configured to rotate. In one or more embodiments, the other end of the spindle 561 is received in the internal manifold 258. Further, the return valve 234 includes an outer recess 562. Disposed within the outer recess is a post 563 that, in one or more embodiments, is configured to engage an armature extending from the internal manifold 258. The armature 564 is arranged at an angle, in particular perpendicular, relative to the post 563, and the armature 564 may be coupled to the internal manifold 258 via a spring 565 (in particular an extension spring) to bias the armature 564 toward the internal manifold 258. In this way, rotation of the return valve 234 causes rotation of the post 563, which in turns causes the armature 564 to extend against the biasing of the spring 565, and when the motor 202 is deactivated, the spring 565 retracts the armature 564, pulling on the post 563 and causing counter rotation of the return valve 234 to re-close the return valve 234.

Returning to FIG. 3A, the tool 100 includes a pressure relief valve 456 (corresponding to the emergency pressure relief valve 240 of FIGS. 2A and 2B) to return fluid to the reservoir 220 in an overpressure event. In one or more embodiments, the pressure relief valve 240 provides fluid communication between the first line 208 and the return line 228.

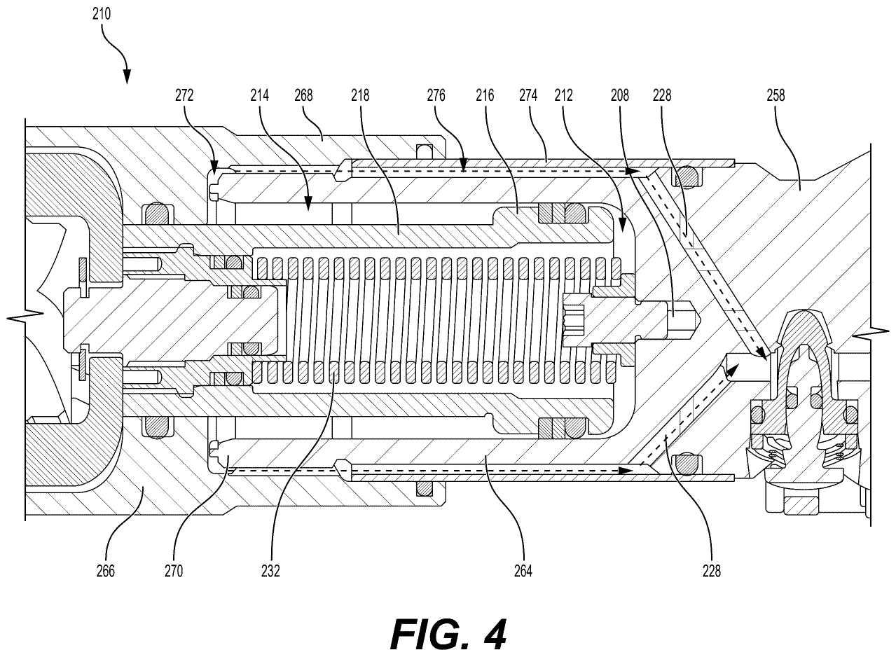

FIG. 4 depicts an embodiment of the hydraulic cylinder 210 according to the present disclosure. As can be seen there, the hydraulic cylinder 210 includes the first chamber 212, the second chamber 214, the piston 216, the hydraulic ram 218, and the spring 232. In the embodiment depicted in FIG. 4, the spring 232 is an extension spring extending within the hydraulic ram 218 and mounted to the floor of the hydraulic cylinder 210. As hydraulic fluid flows into the first chamber 212, the piston 216 and hydraulic ram 218 move in the first direction 222, traveling within a cylinder wall 264 extending from the first manifold 258. The hydraulic ram 218 extends through an end cap 266 having an outer wall 268 that surrounds the cylinder wall 264 along at least a portion of the length of the cylinder wall 264. At a distal end 270 of the cylinder wall 264, the cylinder wall 264 defines one or more openings 272 between the cylinder wall 264 and the end cap 266. The hydraulic cylinder 210 further includes a sleeve 274 around the cylinder wall 264. As shown in FIG. 4, the sleeve 274 engages an outer surface of the manifold 258 and an inner surface of the outer wall 268 of the end cap 266 and defines one or more passages 276 spaced around the outside of the cylinder wall 264. In one or more embodiments, the sleeve 274 engages the inner surface of the outer wall 268 in a threaded connection, and the passages 276 are defined by one or more grooves substantially perpendicularly cut across the threaded inner surface of the outer wall 268 and/or the threaded outer surface of the sleeve 274.

As the piston 216 moves in the first direction 222 (as shown in FIGS. 2A and 2B), decreasing the volume of the second chamber 214, hydraulic fluid is forced to the return line 228. Specifically, the hydraulic fluid flows over the cylinder wall 264, through the annular openings 272 and into the annular passage 276 between the sleeve 274 and the cylinder wall 264. The annular passage 276 is in fluid communication with the return line 228 or return lines 228, which is in fluid communication with the reservoir 220 via the return valve 234.

In conventional hydraulic cylinders, the hydraulic fluid is returned via passages through the cylinder wall, which reduces the durability of the cylinder and diminishes tool life. Accordingly, the presently disclosed flow path through the annular opening 272 and annular passage 276 is expected to increase durability of the presently disclosed tool 100. Further, the forward chamber, i.e., second chamber 214, provides a reservoir for hydraulic fluid, allowing for the size of the reservoir 220 to be decreased.

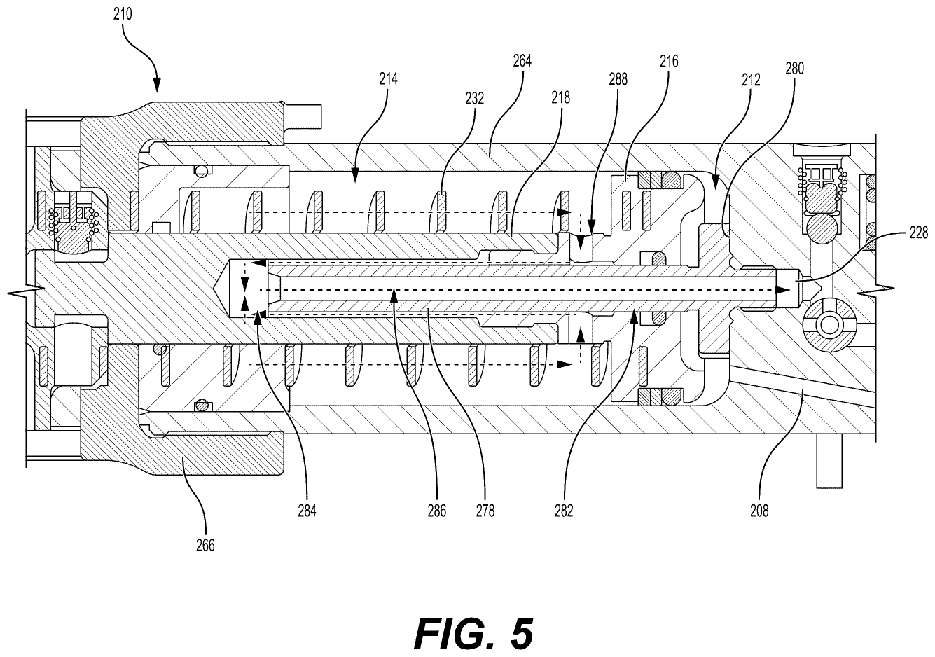

FIG. 5 depicts another embodiment of the hydraulic cylinder 210 according to the present disclosure. The hydraulic cylinder 210 includes the first chamber 212, the second chamber 214, the piston 216, the hydraulic ram 218, the compression spring 232, the cylinder wall 264, and the end cap 266. As shown in FIG. 5, the piston 216 travels along a central post 278. The central post 278 extends from a floor 280 of the hydraulic cylinder 210, through an aperture 282 of the piston 216 and into a central bore 284 of the hydraulic ram 218. The central post 278 includes a flow passage 286 the provides fluid communication through the floor 280 to the return line 228. Additionally, the hydraulic ram 218 or piston 216 includes one or more openings 288 in fluid communication with the central bore 284. In this way, hydraulic fluid forced out of the second chamber 214 flows through the openings 288 in the hydraulic ram 218 or piston 216 into the central bore 284 and into the flow passage 286 of the central post 278. As mentioned, the flow passage 286 leads through the floor 280 of the hydraulic cylinder 210 to flow into the return line 228.

Thus, like the previous embodiment, return flow is not provided through the cylinder wall 264 but through a concentric flow passage to the return line. In the previous embodiment of FIG. 4, the concentric passage was an annular passage outside the cylinder wall 264, whereas in the embodiment of FIG. 5, the concentric flow passage is interior to the cylinder wall 264, in particular interior of the hydraulic ram 218 and piston 216. However, as with the previous embodiment, the embodiment of FIG. 5 also improves durability of the hydraulic cylinder 210 by avoiding the formation of passages in the cylinder wall 264.

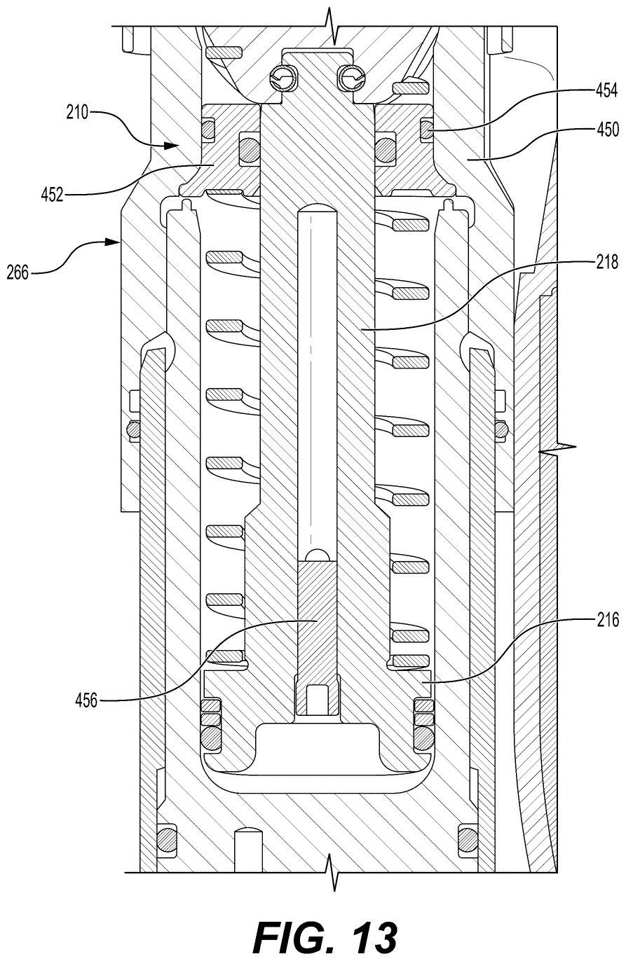

FIG. 13 depicts another embodiment of the hydraulic cylinder 210 similar to the embodiment of FIG. 4 in that the hydraulic cylinder 210 is configured to drain hydraulic fluid concentrically outward. In the embodiment of FIG. 13, the endcap 266 is a two-piece end cap including an outer casing 450 and a central disc 452. The central disc 452 is disposed within the outer casing 450, and the hydraulic ram 218 extends through the central disc 452. In one or more embodiments, the central disc 452 is formed from a steel alloy, whereas the outer casing 450 is formed from an aluminum alloy. The central disc 452 is seated within the outer casing 450 and sealed to the outer casting 450 using a gasket 454. Applicant has found that the two-piece end cap 266 provides advantages over a single piece endcap made of either an aluminum or steel alloy. In particular, using an aluminum ally for the largest portion of the endcap 266 allows for light-weighting of the tool, while the steel alloy central disc 452 provides enhanced strength for interaction with the hydraulic ram 218.

Additionally, in comparing FIGS. 3A and 13, it can be seen that each of the depicted hydraulic cylinders 210 includes a pressure relieve valve 456. In the embodiment shown in FIG. 3A, the pressure relief valve 456 is located in the manifold 258 fluidically between the first chamber 212 and the return line 228. As can be seen in FIG. 13, the pressure relief valve 456 is disposed within the hydraulic ram 218 and piston 216, allowing for the size of the manifold 258 to be reduced.

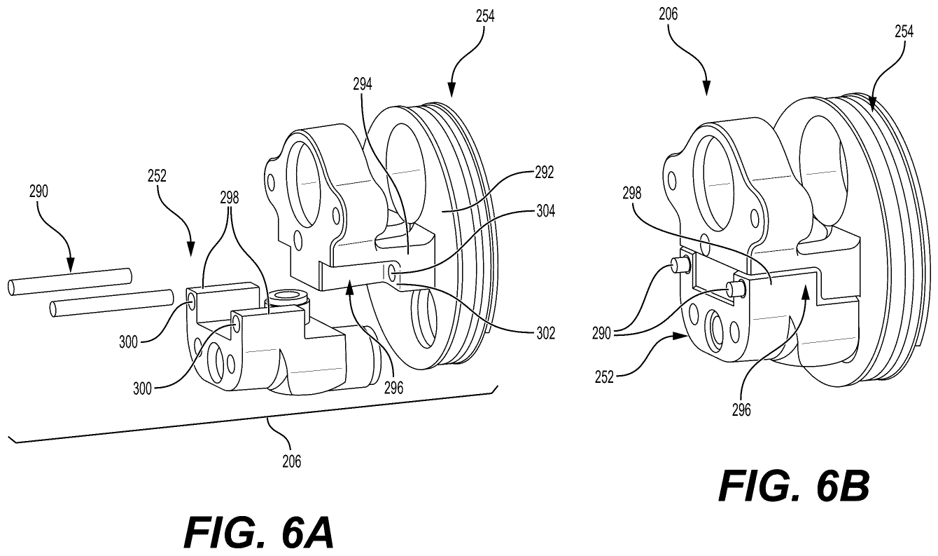

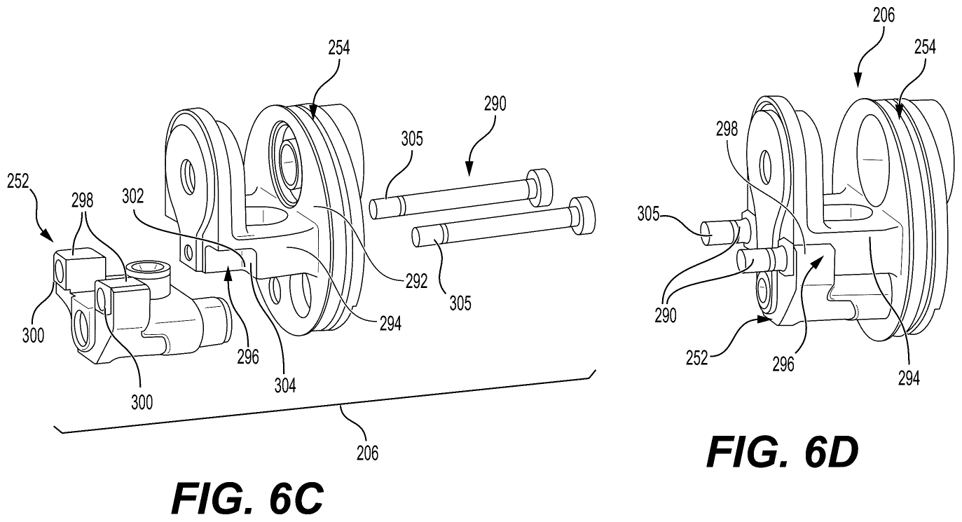

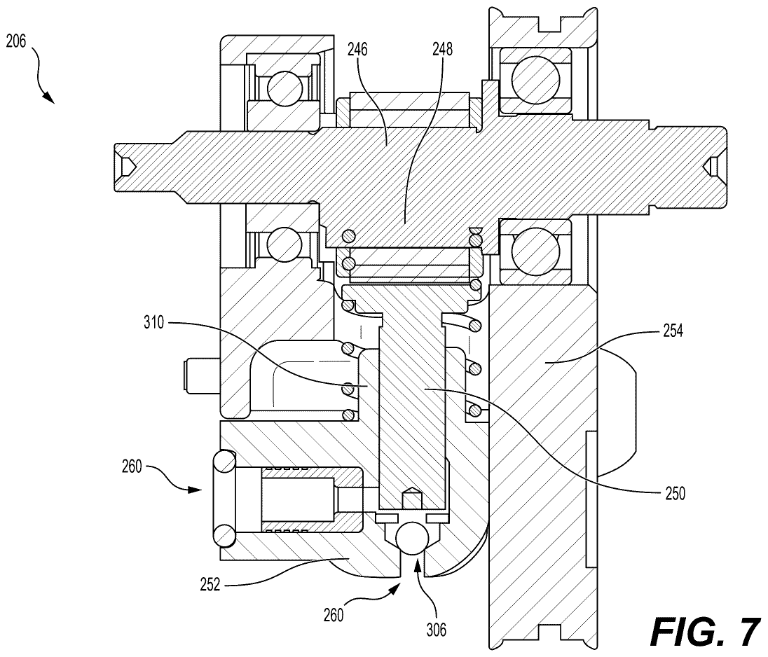

With reference to FIGS. 6A-6D and 7, embodiments of the present disclosure also relate to improvements to the pump 206 of the electrohydraulic press tool 100. With reference first to FIGS. 6A and 6B, a simplified and more durable construction of the pump 206 is depicted. As shown in FIG. 6A, the pump 206 is a two-piece pump with the pump chamber 252 and the pump mount 254. In one or more embodiments, the pump chamber 252 is formed from a steel alloy to provide enhanced durability, whereas the pump mount 254 is formed from an aluminum alloy to reduce weight. In the two-piece pump, the pump chamber 252 is fastened to the pump mount 254. Conventionally, the pump chamber is torqued in order to join it to the pump mount, which can lead to breaking of components or misalignment. According to embodiments of the present disclosure, the pump chamber 252 is fastened to the pump mount 254 using one or more pins 290.

The pump mount 252 includes a base 292, shown as a circular base, having a mounting element 294 extending traverse to, in particular substantially perpendicularly from, the base 292. The mounting element 294 includes two slots 296 that cooperate with mounting arms 298. The mounting arms 298 include through holes 300 extending substantially parallel to the mounting element 294. Each slot 296 of the mounting element 294 includes a bottom abutment surface 302 having receiver holes 304 formed therein.

As shown in FIG. 6B, the mounting arms 298 of the pump chamber 252 are seated in the corresponding slots 296 of the mounting element 294 of the pump mount 254, abutting the abutment surface 302. When the pump chamber 252 is positioned against the mounting element 294 in this manner, the through holes 300 align with the receiver holes 304, and the pins 290 can be inserted through the through holes 300 to be seated in the receiver holes 304, thereby joining the pump chamber 252 with the pump mount 254. In one or more embodiments, the pins 290 are held in place based on positioning of the pump 206. In particular, in one or more embodiments, the pump 206 is positioned such that the pump chamber 252 abuts the manifold 258, thereby preventing the pins 290 from working loose from the through holes 300.

This manner of assembling the pump 206 avoids the need for a threaded connection, and avoids having to torque the pump chamber 252. Further, the assembly is greatly simplified because the connection only requires the insertion of pins through the pump chamber 252 into the pump mount 254.

FIGS. 6C and 6D depict a similar two-piece pump 206 as shown in FIGS. 6A and 6B, but the pins 290 are inserted from the opposite direction in the embodiment shown in FIGS. 6C and 6D. In one or more embodiments, the pins 290 have threaded ends 305. In this way, the pins 290 act as pins with respect to the pump 206 (i.e., the substantial portion of the length of the pins 290 are inserted into receiver holes 304 and the through holes 300), and the threaded ends 305 extending past the pump 206 are threadably mated with the manifold 258, which holds the pump 206 together and attaches the pump 206 to the manifold 258.

Referring now to FIG. 7, the pump 206 has a check valve 306 incorporated into a piston bore 310 of the pump 206. In the cross-sectional view of the pump 206, the plunger 250 is disposed within a piston bore 310. In one or more embodiments, the check valve 306 is arranged in an inlet 308 of the pump 206 that is coaxial with the piston bore 310; however, in one or more other embodiments, the check valve 306 may be arranged in an outlet 309 of the pump 206 instead. Advantageously, the incorporation of the check valve 306 into the piston bore 310 of the pump 206 in this manner simplifies machining of the pump 206, increases pump efficiency at pressure because of the coaxial arrangement of the inlet 308, check valve 306, and piston bore 310, and reduces sensitivity to the presence of air in the hydraulic system while operating in normal orientations.

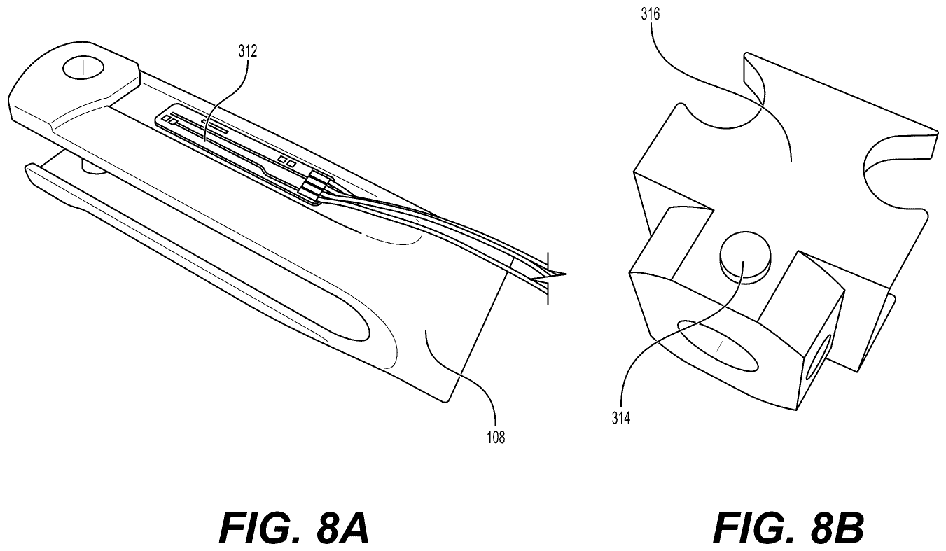

As mentioned above in relation to FIG. 1B, the tool 100 includes a selector switch 122 for selecting between a long stroke of the hydraulic ram and a short stroke of the hydraulic ram. FIG. 8 depicts an example embodiment of a system for controlling the length of the stroke based on the selector switch 122. As shown in FIGS. 8A and 8B, the sensor for controlling the stroke length is incorporated into the clevis 108. In one or more embodiments, the clevis 108 has a sensor 312, such as a Hall sensor, mounted thereon. In one or more embodiments, a stimulator 314, such as a magnet, is mounted on a roller carrier 316 coupled to the hydraulic ram 218. As the hydraulic ram 218 and, thus, the roller carrier 316 are moved within the clevis 108, the sensor 312 will detect the stimulator 314 as the roller carrier 316 passes by the sensor 312.

In one or more embodiments, the sensor 312 is positioned along the clevis 108 at the position corresponding to the short stroke length such that, when the sensor 312 detects the stimulator 314, the hydraulic ram 218 is stopped in the short stroke position. That is, for a tool with a selectable stroke length (e.g., as shown in FIG. 1B) and in which the short stroke length is selected, the tool 100 does not fully retract the hydraulic ram 218 after a pressing operation. In this way, the short stroke length of the tool 100 starts from the hydraulic ram 218 at an intermediate position, which may be 20%, 30%, 40%, or 50%, for example, of the long stroke length.

In one or more embodiments, the sensor 312 is connected to the PCBA 262 such that, when the sensor 312 detects the magnet 314, the sensor 312 sends a signal to a controller to cause the motor 202 to close the shear seal valve 234 (or allow closure of the shear seal valve 234) to prevent further draining of the hydraulic fluid from the first chamber 212 of the hydraulic cylinder 210, thereby preventing the compression spring 232 from driving the hydraulic ram 218 fully back to the long stroke start position.

Advantageously, providing a short stroke length for the tool 100 that is capable of a long stroke length saves the user time when the user needs to perform a substantial number of pressing operations that only require a short stroke length. Instead of waiting for the hydraulic ram to fully retract after each pressing operation, the user can set up and perform the next pressing operation more quickly.

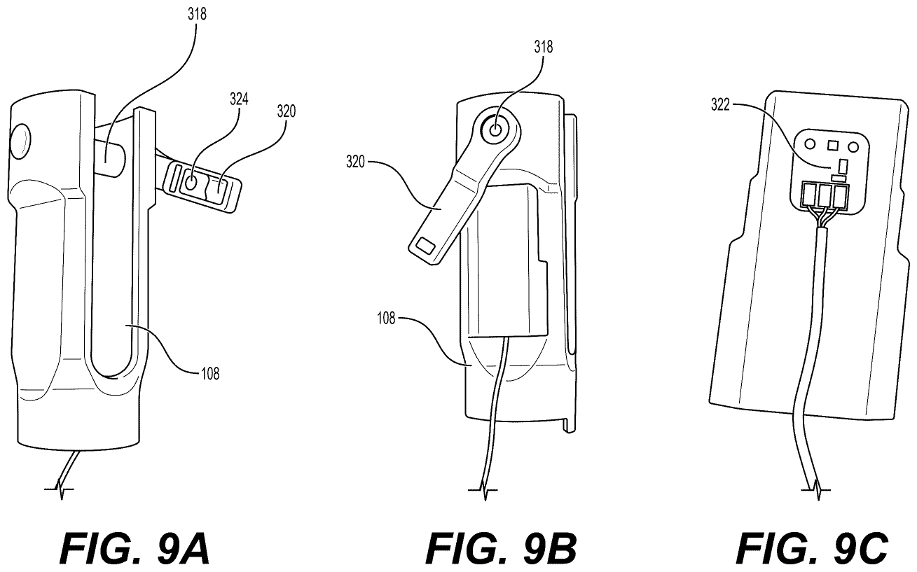

FIGS. 9A-9C depict an embodiment of a system for electronic detection of proper insertion of a pin 318 into the clevis 108. When attaching press jaws to the tool 100, the pin 318 is removed from the clevis 108, and the press jaws are positioned within the clevis 108. The pin 318 is then inserted through one arm of the clevis 108, a through hole of the press jaw, and into the other arm of the clevis 108. To ensure proper operation of the tool 100, the press jaws should be securely connected to the clevis 108 with the pin 318. In one or more embodiments, the pin 318 locks to the clevis 108 in any of a variety of suitable ways known in the art. According to one or more embodiments of the present disclosure, the tool 100 checks for proper insertion and locking of the pin 318 in the clevis 108 before allowing the initiation of a pressing operation.

As shown in FIGS. 9A-9C, the pin 318 includes a flag 320 that extends substantially perpendicular to the pin 318. When the pin 318 is properly inserted and locked in place, the flag 320 is aligned with the longitudinal axis of the clevis 108. In one or more embodiments, the clevis 108 includes a second sensor 322, such as a second Hall sensor, configured to detect a second stimulator 324, such as a second magnet, in the flag 320 of the pin 318. In this way, when the pin 318 is properly inserted in the clevis 108 with the flag pointed downward along the longitudinal axis of the clevis 108 to lock the pin 318 in place, the second sensor 322 detects the second stimulator 324 of the flag 320. In one or more embodiments, the controller of the tool 100 will require detection of the second stimulator 324 by the second sensor 322 to initiate a pressing operation.

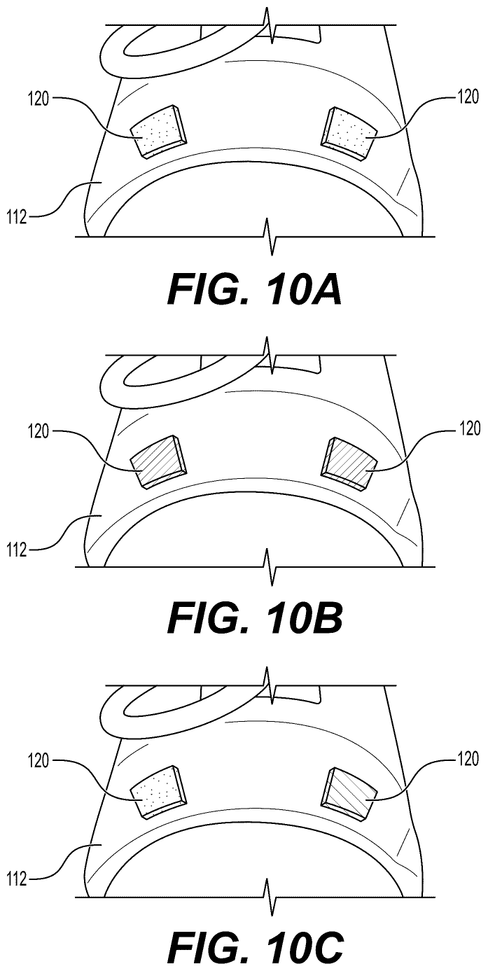

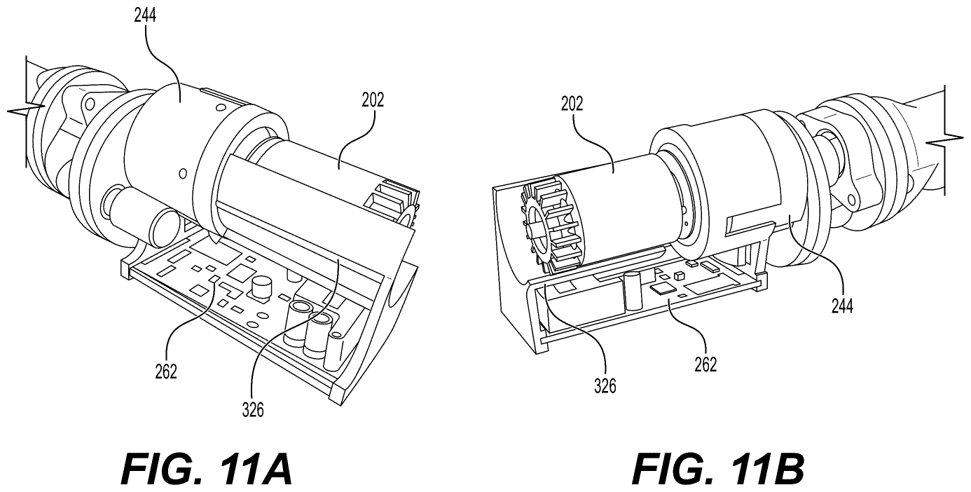

As discussed above in relation to FIGS. 1A-1C, the LED 120 on the collar 112 of the housing 126 can be used to indicate a status of the tool 100 to the user or to provide illumination. In FIG. 10A, for example, the LED 120 may emit white light for illumination of the workpiece. In FIG. 10B, for example, the LED 120 may emit green light to indicate a successful pressing operation, i.e., that the pressure transducer 136 detected that a predetermined pressure threshold indicative of successful pressing was reached. In FIG. 10C, for example, one LED 120 emits a white light, and the other LED 120 emits a red light. Such a combination of lights can be used to indicate an unsuccessful pressing operation, another error, or a particular status condition, such as low battery charge. In one or more embodiments, the combination of LED colors used and length of flashing (e.g., short pluses vs long pulses vs. solid light) can be configured to communicate a variety of different messages to a user.

FIGS. 11A and 11B depicts an embodiment of a component configured to organize electronic elements and simplify their installation within the housing of the tool 100. In particular, FIGS. 11A and 11B depict a mounting sled 326 for the PCBA 262. Advantageously, the mounting sled 326 provides a substrate to which the PCBA 262 can be mounted outside of the housing 126 of the tool 100. Further, the sled 326 can include guide channels for routing of wires in an organized manner, which is also easier to manage outside the confines of the housing 126. After mounting of the PCBA 262 and any other components along with routing of wires, the mounting sled 326 can then be positioned within the housing 126. In the embodiment shown in FIGS. 11A and 11B, the mounting sled 326 is secured to the gearbox 244, and then the housing 126 can be formed (e.g., by combining clamshell-type housing components) around the mounting sled 326 and other interior components.

Additional details are shown and described in the accompanying figures.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. An electrohydraulic tool, comprising:
a motor;
a pump driven by the motor;
a hydraulic cylinder comprising a hydraulic ram, an inlet, and an outlet; and
a rotary valve;
wherein the pump is in fluid communication with the inlet of the hydraulic cylinder;
wherein, when the motor is driven in a first rotational direction, the motor drives the pump to pump hydraulic fluid into the hydraulic cylinder to move the hydraulic ram from a retracted position to an extended position;
wherein, when the motor is driven in a second rotational direction opposite to the first rotational direction, the rotary valve is rotated from a closed position to an open position; and
wherein rotating the rotary valve to the open position allows hydraulic fluid to drain from the hydraulic cylinder through the outlet so that the hydraulic ram moves from the extended position to the retracted position.

2. The electrohydraulic tool of claim 1, wherein the rotary valve is in fluid communication with the outlet of the hydraulic cylinder such that hydraulic fluid drains from the hydraulic cylinder through the rotary valve when the rotary valve is in the open position.

3. The electrohydraulic tool of claim 1, further comprising a release valve in fluid communication with the outlet of the hydraulic cylinder, wherein, when the rotary valve is in the closed position, the release valve is in a closed position such that hydraulic fluid cannot drain from the hydraulic cylinder through the release valve and wherein, when the rotary valve is in an open position, the release valve is in an open position such that hydraulic fluid drains from the hydraulic cylinder through the release valve.

4. The electrohydraulic tool of claim 3, wherein a pilot line connects the pump and the rotary valve, wherein, in a closed position, hydraulic fluid on the pilot line is at a pilot pressure and, in an open position, hydraulic fluid on the pilot line is at a drain pressure, and wherein the release valve comprises a pilot port connected to the pilot line.

5. The electrohydraulic tool of claim 4, wherein the release valve comprises:
a valve body comprising an inlet port, an outlet port, the pilot port, and a valve seat disposed between the inlet port and the outlet port; and
a valve member;
wherein the valve member is seated against the valve seat in the closed position of the release valve and is unseated from the valve seat in the open position of the release valve; and
wherein a line pressure of hydraulic fluid between the outlet of the hydraulic cylinder and the inlet port is less than the pilot pressure such that the pilot pressure is sufficient to keep the valve member seated against the valve seat.

6. The electrohydraulic tool of claim 5, wherein the release valve further comprises a plunger configured to manually actuate the valve member to unseat valve member from the valve seat when the plunger is pressed against the valve member.

7. The electrohydraulic tool of claim 6, wherein the plunger is spring-biased away from the valve member.

8. The electrohydraulic tool of claim 1, further comprising a hydraulic fluid reservoir;
wherein the hydraulic cylinder comprises a first chamber, a second chamber, a piston, and a hydraulic ram, the piston separating the first chamber from the second chamber and the hydraulic ram mounted on the piston; and
wherein the second chamber is connected to the hydraulic fluid reservoir by a return flow path such that the return flow path comprises at least a portion that is arranged concentrically with the hydraulic cylinder.

9. The electrohydraulic tool of claim 8, wherein the return flow path comprises a sleeve that is arranged concentrically outside the hydraulic cylinder.

10. The electrohydraulic tool of claim 8, wherein the hydraulic cylinder further comprises a post having a central flow passage, wherein the piston and hydraulic ram translate within the hydraulic cylinder along the post, and wherein at least one of the hydraulic ram or the piston comprises one or more openings to provide fluid communication between the second chamber and the central flow passage of the post.

11. The electrohydraulic tool of claim 1, wherein the motor comprises a first driveshaft mechanically coupled to a gearbox transmission, wherein the gearbox transmission is mechanically coupled to a first end of a second driveshaft configured to drive the pump, and wherein the rotary valve is mechanically coupled to a second end of the second driveshaft opposite to the first end.

12. The electrohydraulic tool of claim 11, wherein the rotary valve is mechanically coupled to the second end of the second driveshaft with a one-way bearing such that the rotary valve does not rotate when the second driveshaft rotates in the first rotational direction and does rotate when the second driveshaft rotates in the second rotational direction.

13. The electrohydraulic tool of claim 11, wherein the gearbox transmission comprises a planetary gear system disposed within a gearbox housing;
wherein, within the gearbox housing, a ring gear of the planetary gear system is configured to rotate an arcuate distance from a first stop to a second stop; and
wherein, upon contacting the second stop, the ring gear is fixed in place so that the planetary gear system is able to transfer rotation from the first driveshaft to the second driveshaft.

14. The electrohydraulic tool of claim 13, wherein the arcuate distance corresponds to rotation of from 20° to 170° within the gearbox housing.

15. The electrohydraulic tool of claim 11, wherein the rotary valve comprises a first component and a second component;
wherein the second component is mechanically coupled to the second driveshaft;
wherein one of the first component or the second component comprises an arcuate recess between a first stop and a second stop; and
wherein the other of the first component or the second component comprises an arm member configured to travel within the arcuate recess from the first stop to the second stop such that, when the second driveshaft rotates in the second rotational direction, the arm member contacts the second stop to transfer rotation to the first component and move the rotary valve to the open position.

16. The electrohydraulic tool of claim 1, wherein the rotary valve is connected to an armature configured to reset the rotary valve to the closed position upon deactivation of the motor.

17. An electrohydraulic tool, comprising:
a motor;
a two-piece pump comprising a pump chamber and a pump mount;
a hydraulic cylinder comprising a hydraulic ram;
a fluid manifold disposed between the hydraulic cylinder and the pump; and
a hydraulic fluid reservoir;
wherein the motor drives the two-piece pump to draw hydraulic fluid from the hydraulic fluid reservoir and pumps the hydraulic fluid into the hydraulic cylinder through the fluid manifold to move the hydraulic ram to an extended position; and
wherein the pump chamber is joined to the pump mount with one or more pins that are held in place by the fluid manifold.

18. The electrohydraulic tool of claim 17, wherein the pump chamber is comprised of a steel alloy and the pump mount is comprised of an aluminum alloy.

19. The electrohydraulic tool of claim 17, wherein the two-piece pump further comprises a plunger that is configured to reciprocate along a pump axis within the pump chamber;
wherein the pump chamber comprises an inlet arranged in line with the plunger along the pump axis; and
wherein a one-way check valve is disposed in the inlet to allow flow of the hydraulic fluid into the pump chamber through the inlet and prevents flow of the hydraulic fluid out of the pump chamber through the inlet.

20. The electrohydraulic tool of claim 17, wherein the hydraulic fluid reservoir is disposed around the two-piece pump, the hydraulic fluid reservoir having a first end engaging the fluid manifold and a second end, opposite the first end, engaging the pump mount.

21. An electrohydraulic tool, comprising:
an electrohydraulic drive system configured to drive a hydraulic ram within a hydraulic cylinder;
a controller configured to control the electrohydraulic drive system;
a housing surrounding the electrohydraulic drive system, the hydraulic cylinder, and the controller;
a clevis extending from a first end of the housing, the clevis comprising a first clevis arm and a second clevis arm; and
a clevis pin configured to be inserted into clevis to hold a working head between the first clevis arm and the second clevis arm;
wherein, after inserting the clevis pin into the clevis, the clevis pin is configured to be rotated from an unlocked position in which the clevis pin can be withdrawn from the clevis to a locked position in which the clevis pin cannot be withdrawn from the clevis;
wherein the first clevis arm comprises a first sensor in communication with the controller and the clevis pin comprises a flag configured to be detected by the sensor when the clevis pin is in the locked position; and
wherein the controller only activates the electrohydraulic drive system after the sensor detects the flag of the clevis pin in the locked position.

22. The electrohydraulic tool of claim 21, wherein the flag comprises a magnet and wherein the sensor is a Hall effect sensor.

23. The electrohydraulic tool of claim 21, wherein the hydraulic ram has a retracted position and an extended position, wherein the second clevis arm comprises a second sensor in communication with the controller, wherein the second sensor is configured to detect a distal end of the hydraulic ram as the hydraulic ram is retracted from the extended position toward the retracted position, and wherein, upon sensing the distal end of the hydraulic ram by the sensor, the controller stops retraction of the hydraulic ram at an intermediate position between the extended position and the retracted position.

24. The electrohydraulic tool of claim 23, further comprising a selector switch, wherein the selector switch is configured to be toggled between a first stetting and a second setting, the first setting causing the hydraulic ram to retract to the retracted position and the second setting causing the hydraulic ram to retract to the intermediate position.

25. The electrohydraulic tool of claim 21, wherein the housing comprises a collar surrounding the clevis, the collar comprising a first surface disposed in a plane transverse to a longitudinal axis of the electrohydraulic tool, wherein a plurality of RGB LED lights are disposed in the first surface, and wherein the controller is configured to cause the plurality of RGB LED lights to illuminate or blink for a particular time and in a particular color to indicate a stage of operation or a result of operation of the electrohydraulic tool.
